(19) United States
(12) Patent Application Publication
(10) Pub. No.: US 2003/0001717 A1
(43) Pub. Date: Jan. 2, 2003

(54) Surface mountable PTC chips

(76) Inventor: Mengruo Zhang, Hong Kong (HK)

Correspondence Address: LEYDIG VOIT & MAYER, LTD, 700 THIRTEENTH ST. NW, SUITE 300, WASHINGTON, DC, 20005-3960, US

(21) Appl. No.: 09/895,069

(22) Filed: Jul. 2, 2001

(51) Int. Cl. H01C 7/10

(52) U.S. Cl. 338/22 R

(57) ABSTRACT

A surface mountable PTC chip comprising a cuboidal body having opposite ends or end surfaces and formed by at least two conductive PTC polymer sheets and top and bottom and at least one intermediate conductive metal foil interlacing with the polymer sheets to form a multi-layered structure. Each top/bottom metal foil is divided by a gap to form a pair of larger and smaller electrodes at opposite positions as compared between top and the bottom body surfaces. The intermediate metal foil extends from one body end surface and reaches short of the opposite end surface to permit integral inter-connection of the polymer sheets. A pair of electrical terminals are located at respective opposite body ends, each of which covers the entire respective body end surface and covers and is in electrical contact with adjoining portions of the larger and smaller electrodes on the top and bottom body surfaces. One terminal is in electrical contact with an end of the intermediate metal foil extending from the same body end exposed on that end surface. Each body end has a recessed surface profile formed by a recess, and the corresponding terminal assumes the same profile.

Each terminal may be in the form of a cap covering the respective body end surface and the adjoining portions of all four side surfaces of the body surrounding that body end.

The present invention relates to surface mountable PTC (positive temperature coefficient) chips.

### BACKGROUND OF THE INVENTION

Surface mountable PTC chips, or sometimes referred to as multi-layered PTC elements, for use as fuses and thermistors are known, for example as disclosed in European patent applications published under Publication Numbers EP 1020877 and EP 1030316.

The invention provides a surface mountable PTC chip that has improved characteristics such as solderability.

### SUMMARY OF THE INVENTION

According to a first aspect of the invention, there is provided a surface mountable PTC chip comprising a flat rectangular cuboidal body having opposite first and second ends or end surfaces and top and bottom surfaces and formed by at least two conductive PTC polymer sheets and top and bottom and at least one intermediate conductive metal foil interlacing with the polymer sheets to form a multi-layered structure. The polymer sheets are integrally inter-connected. Each of the top and bottom metal foils is divided by a transversely extending gap to form a pair of larger and smaller electrodes at opposite positions as compared between the top and the bottom surfaces of the body. The intermediate metal foil extends from one end surface of the body and reaches short of the opposite end surface to permit integral inter-connection of the polymer sheets. A pair of electrical terminals are located at respective opposite ends of the body, each of which covers substantially the entire respective end surface of the body and covers and is in electrical contact with adjoining portions of the larger and smaller electrodes on the top and bottom surfaces of the body. One of the terminals is in electrical contact with an end of the intermediate metal foil extending from the same body end exposed on that end surface. An insulating layer is located on each of the top and bottom surfaces of the body between the two terminals. Each end of the body has a recessed surface profile formed by a recess extending across the top and bottom surfaces of the body and the corresponding terminal assumes substantially the same recessed surface profile.

Preferably, the body is formed by at least three said conductive PTC polymer sheets and said top and bottom and at least two said intermediate conductive metal foils interlacing with the polymer sheets to form a multi-layered structure. The two intermediate metal foils extend in opposite directions from respective first and second end surfaces of the body and reach short of the opposite end surfaces to permit integral inter-connection of the polymer sheets. Each electrical terminal is in electrical contact with an end of the respective intermediate metal foil extending from the same body end exposed on that end surface.

Preferably, each recess is formed at substantially the central position of the corresponding end of the body.

In a preferred embodiment, each recess has a curved cross-section.

Preferably, each recess is substantially semi-cylindrical.

It is preferred that each recess occupies substantially the entire width of the corresponding end of the body.

In another preferred embodiment, each recess has a substantially V-shaped cross-section.

Preferably, each recess occupies substantially the entire width of the corresponding end of the body.

According to a second aspect of the invention, there is provided a surface mountable PTC chip comprising a flat rectangular cuboidal body having opposite first and second ends or end surfaces and top and bottom surfaces and formed by at least one conductive PTC polymer sheet and at least top and bottom conductive metal foils interlacing with the polymer sheet to form a multi-layered structure. Each of the top and bottom metal foils is divided by a transversely extending gap to form a pair of larger and smaller electrodes at opposite positions as compared between the top and the bottom surfaces of the body. A pair of electrical terminals are located at respective opposite ends of the body, each of which covers and is in electrical contact with adjoining portions of the larger and smaller electrodes on the top and bottom surfaces of the body. An insulating layer is located on each of the top and bottom surfaces of the body between the two terminals. Each terminal is in the form of a cap covering the entire respective end surface of the body and the adjoining portions of all four side surfaces of the body surrounding the same body end.

Preferably, the body is formed by at least two conductive PTC polymer sheets and top and bottom and at least one intermediate conductive metal foil interlacing with the polymer sheets to form a multi-layered structure. The polymer sheets are integrally inter-connected. The intermediate metal foil extends from one end surface of the body and reaches short of the opposite end surface to permit integral inter-connection of the polymer sheets.

More preferably, the body is formed by at least three said conductive PTC polymer sheets and said top and bottom and at least two said intermediate conductive metal foils interlacing with the polymer sheets to form a multi-layered structure. The two intermediate metal foils extend in opposite directions from respective first and second end surfaces of the body and reach short of the opposite end surfaces to permit integral inter-connection of the polymer sheets.

It is preferred that the or each intermediate metal foil has an end edge exposed on the end surface of the body from which the foil extends and opposite left and right side edges exposed on respective left and right side surfaces of the body. The terminal at the same body end is in electrical contact with said end edge and adjoining portions of said left and right side edges.

In a preferred embodiment, each terminal is in the form of a substantially rectangular cap formed by an end wall and four side walls.

### BRIEF DESCRIPTION OF DRAWINGS

The invention will now be more particularly described, by way of example only, with reference to the accompanying drawings, in which:

FIG. 1 is a perspective view of a first embodiment of a surface mountable PTC chip in accordance with the invention;

FIG. 2 is a sectioned perspective view corresponding to FIG. 1, showing half of the PTC chip;

FIGS. 3A to 3D are perspective views showing various steps in the production of the PTC chip of FIG. 1;

FIG. 4 is a perspective view of a second embodiment of a surface mountable PTC chip in accordance with the invention;

FIG. 5 is a sectioned perspective view corresponding to FIG. 4, showing half of the PTC chip;

FIG. 6 is a perspective view of a second embodiment of a surface mountable PTC chip in accordance with the invention;

FIG. 7 is a sectioned perspective view corresponding to FIG. 6, showing half of the PTC chip;

FIG. 8 is a perspective view of a fourth embodiment of a surface mountable PTC chip in accordance with the invention;

FIG. 9 is a sectioned perspective view corresponding to FIG. 8, showing half of the PTC chip;

FIGS. 10A to 10D are perspective views showing various steps in the production of the PTC chip of FIG. 8;

FIG. 11 is a perspective view of a fifth embodiment of a surface mountable PTC chip in accordance with the invention; and

FIG. 12 is a sectioned perspective view corresponding to FIG. 11, showing half of the PTC chip;

### DETAILED DESCRIPTION OF PREFERRED EMBODIMENTS

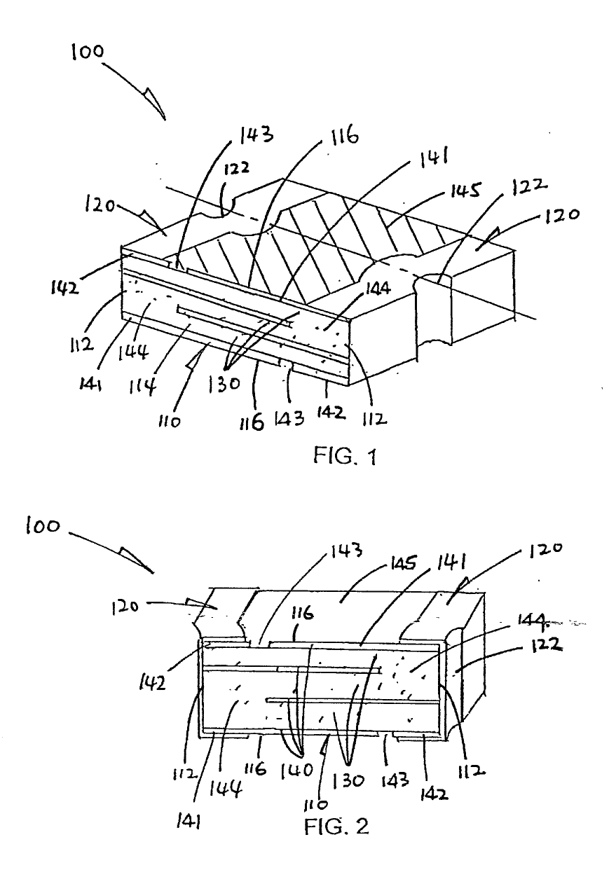

Referring initially to FIGS. 1 and 2 of the drawings, there is shown a first surface mountable PTC chip 100 embodying the invention, which chip 100 has a flat rectangular cuboidal body 110 and a pair of copper terminals 120 located at opposite ends 112 of the body 110. The chip body 110 has a pair of opposite end surfaces 112 covered by the respective terminals 120, a pair of left and right side surfaces 114 and a pair of top and bottom surfaces 116. The chip body 110 is formed by three conductive PTC polymer sheets 130 and four electrolytic copper foils 140 which interlace with the polymer sheets 130 to form a multi-layered structure.

Each of the two outer copper foils 140 is formed with a gap 143 that extends transversely across the chip body 110. The gap 143 divides the corresponding copper foil 140 into two, relatively larger and smaller electrodes 141 and 142 on the corresponding top/bottom body surface 116. The two gaps 143 are located at the same horizontal distance but from opposite body end surfaces 112, such that each body end 112 is associated with a pair of larger and smaller electrodes 141 and 142 from the opposite top and bottom surfaces 116.

The two inner (intermediate) copper foils 140 extend horizontally in opposite directions from respective opposite end surfaces 112 of the chip body 110, where their edge faces are exposed. However, each of the copper foils 140 reaches short of the other opposite end surface 112 at the far end, thereby forming a respective gap 144 at the far end extending transversely across the chip body 110.

Each inner copper foil 140 is pre-formed with an aperture to form the respective gap 144, upon being cut out from a blank of larger copper foil. The two polymer sheets 130 immediately above and below each of the gaps 144 merge integrally together through and filling up the gap 144 as a result of a hot pressing process, whereby all the three polymer sheets 130 are integrated into a one-piece PTC element.

Each terminal 120 has a rectangular C-shaped cross-section and is formed by using a plating process on the corresponding end 112 of the chip body 110. The terminal 120 covers the entire end surface 112 and the adjoining portions of the top and bottom body surfaces 116. The terminal 120 is in electrical contact or connection with the pair of larger and smaller electrodes 141 and 142 associated with that body end 112 and also in electrical connection with the exposed edge face of the relevant inner copper foil 140 extending from the same body end 112. By means of the corresponding sets of interconnected outer electrodes 141 and 142 and inner copper foil 140 (acting as the third electrode), the two terminals 120 allow electrical current to flow through the one-piece PTC element 130 for operation.

The two terminals 120 also serve as supports for mounting and connecting the PTC chip 100 on a printed circuit board by means of soldering in a flow soldering process. A semi-cylindrical recess 122 is formed at the central position of each end 112 of the chip body 110, extending vertically across the top and bottom body surfaces 116. The recess 122 is formed prior to the formation of the corresponding terminal 120, such that the terminal 120 assumes the same recessed surface profile as the end surface 112.

The recessed surface profile of the body end surfaces 112 increases the length of the exposed edge faces of the inner copper foils 140, whereby the contact area between the said exposed edge faces and the inner surfaces of the respective terminals 120 is increased to achieve better electrical connection. By reason of the recessed surface profile, the outer surface area of the terminals 120 available for soldering is increased, which does not only improve the strength of the soldering connection but also introduces interlocking between the terminals 120 and the solder to avoid lateral displacement.

The middle portion of the outer copper foil 140 as exposed between the two terminals 120, including the gap 143, on each top/bottom surface 116 of the chip body 110 is protected by a respective insulating layer or solder mask 145 deposited thereon.

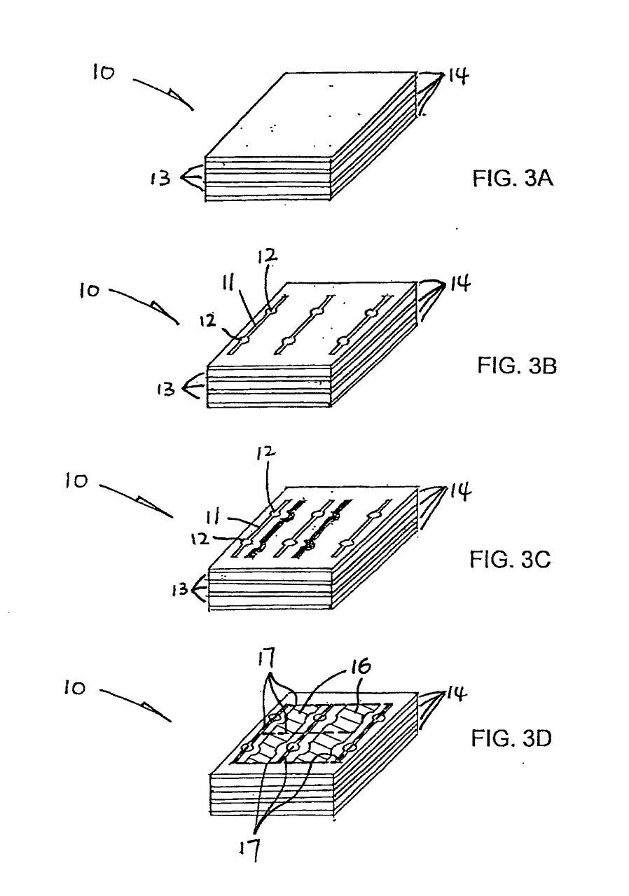

The method of manufacturing the PTC chip 100 will now be described. FIG. 3A shows a lamination 10 of four electrolytic copper foils 14 and three interlacing conductive PTC polymer sheets 13, which acts as a blank from which a number of PTC chips 100 are to be made. The two inner copper foils 14 are pre-cut by using a stamping process to form an array of apertures that act as the aforesaid gaps 144. The lamination 10 is assembled tight by subjecting the stack of copper foils 14 and polymer sheets 13 to a hot pressing process, whereby the polymer sheets 13 adhere the interlacing copper foils 14 together, with the polymer sheets 13 merging integrally together through and filling up the aforesaid apertures.

FIG. 3B shows the formation of combined straight slots 11 and circular holes 12 vertically through the lamination 10 by drilling and milling operations to form the recessed end surfaces 112 of the bodies 110 of the PTC chips 100. Opposite sides of the slots 11 form the general end surfaces 112, whereas opposite sides of the holes 12 form the semi-cylindrical central recesses 122 in the end surfaces 112. The inner surfaces of the slots 11 and holes 12, together with the portions of the top and bottom outer lamination surfaces surrounding them, are then plated with a copper coating to eventually form the terminals 120.

FIG. 3C shows the formation of oblong gaps 15 in each of the top and bottom copper foils 14 by any commonly known etching method. The gaps 15 eventually form the aforesaid gaps 143, as part of the formation of the electrodes 141 and 142 on the top and bottom surfaces 116 of the chip bodies 110.

FIG. 3D shows the formation of insulating layers or solder masks 16 on the outer surface of each of the top and bottom copper foils 14 covering the gaps 15, which eventually form the solder masks 145 on the top and bottom surfaces 116 of the chip bodies 110. Finally, the lamination 10 is cut along lines 17 to produce individual PTC chips 100.

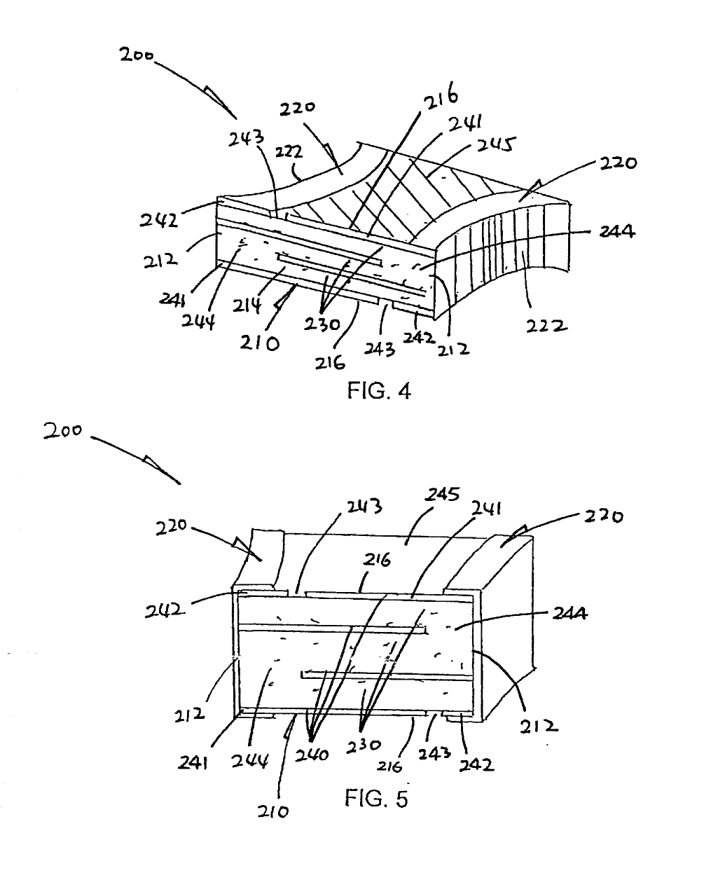

Referring next to FIGS. 4 and 5 showing a second surface mountable PTC chip 200 embodying the invention, this chip 200 has almost the same construction as the first PTC chip 100 and is manufactured by identical method, with equivalent parts designated by the same reference numerals increased by “100”. The only difference lies in the shape of the recesses 222 at respective opposite ends 212 of the chip body 210, and in turn the shape of the terminals 220 dictated thereby.

In this embodiment, each of the recesses 222 has an inwardly curved shape, when viewed from above or below, occupying the entire width of the respective body end 212, thereby resulting in a convex overall surface profile for the body end 212. The aforesaid advantages also exist in the present recessed surface profile.

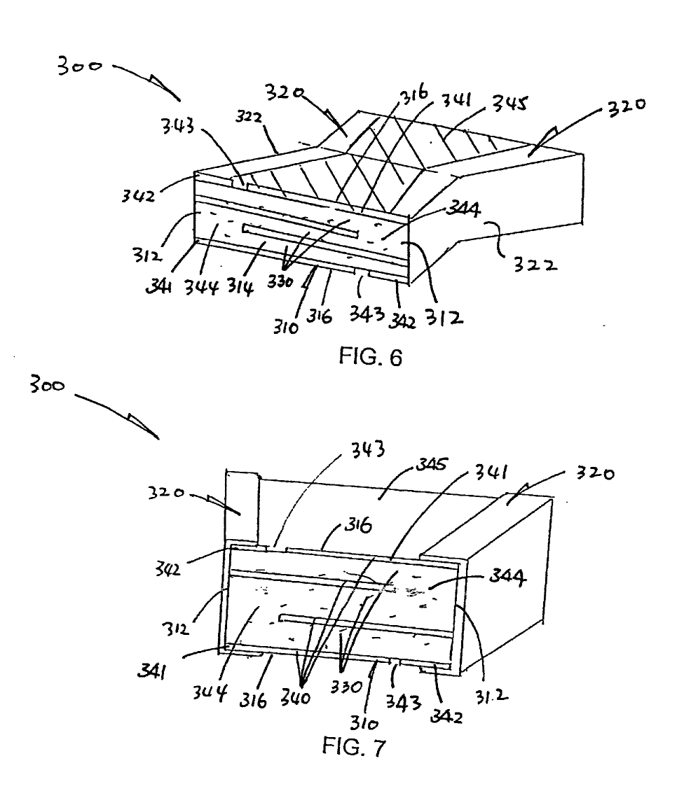

Referring then to FIGS. 6 and 7 showing a third surface mountable PTC chip 300 embodying the invention, this chip 300 has almost the same construction as the second PTC chip 200 and is manufactured by identical method, with equivalent parts designated by the same reference numerals increased by “100”. The only difference lies in the shape of the recesses 322 at respective opposite ends 312 of the chip body 310, and in turn the shape of the terminals 320 dictated thereby.

In this embodiment, each of the recesses 322 has a shape which resembles a flat letter “V” when viewed from above or below and occupies the entire width of the respective body end 312, thereby resulting in a flat V-shaped overall surface profile for the body end 312. The aforesaid advantages also exist in the present recessed surface profile.

It is understood that the body 110/210/310 of each PTC chip 100/200/300 may comprise at least two conductive PTC polymer sheets 130/230/330 and at least one intermediate conductive metal foil 140/240/340.

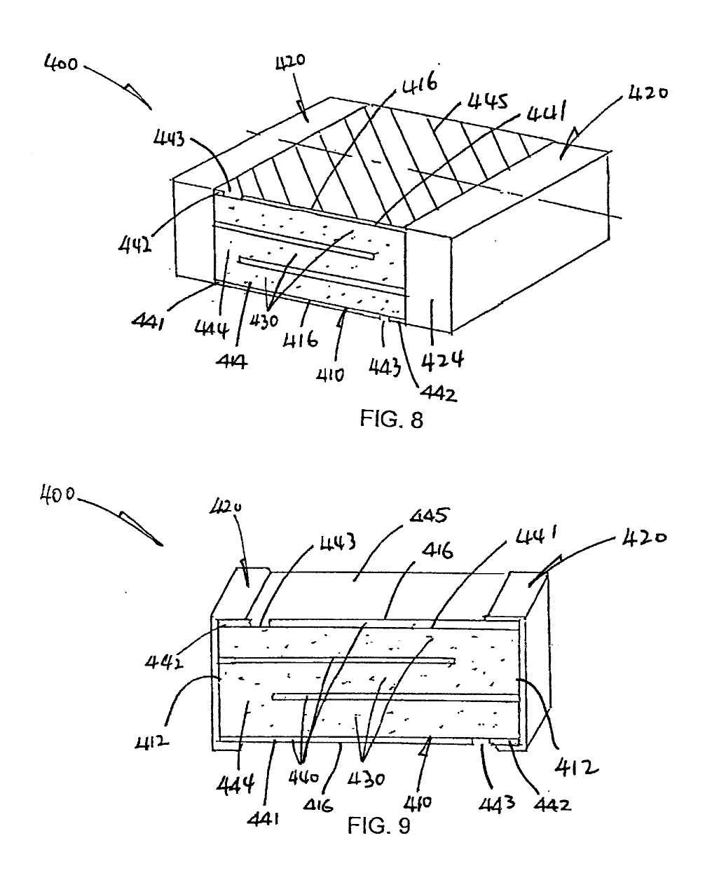

Reference is now made to FIGS. 8 and 9 of the drawings, there is shown a fourth surface mountable PTC chip 400 embodying the invention, which chip 400 has similar construction as the first PTC chip 100 and is manufactured by almost the same method, with equivalent parts designated by the same reference numerals increased by “300”. In terms of construction, there are two differences both concerning the terminals 420.

Each terminal 420 is likewise produced by using a plating process on the corresponding end 412 of the chip body 410. The terminal 420 is in the form of a rectangular cap (formed by an end wall and four side walls as shown) covering the entire end surface 412 and the adjoining portions of all four side surfaces of the body 410 surrounding that body end 412, i.e. the top and bottom surfaces 416 and the left and right side surfaces 414. Compared with the aforesaid terminals 120, the present terminals 420 includes additional left and right side walls 424 which are in electrical contact or connection with adjoining portions of the exposed left and right edge faces respectively of the relevant inner copper foil 440 extending from the same body end 412.

The presence of the left and right side walls 424 increases the contact length or area of each terminal 420 with the exposed edge faces of the relevant inner copper foils 440 i.e. the end edge face and adjoining portions of the left and right side edge faces, thereby achieving better electrical connection. By reason of the presence of such side walls 424, the outer surface area of each terminal 420 available for soldering is increased, which does not only improve the strength of the soldering connection but also introduces interlocking between the terminal 420 and the solder to avoid lateral displacement.

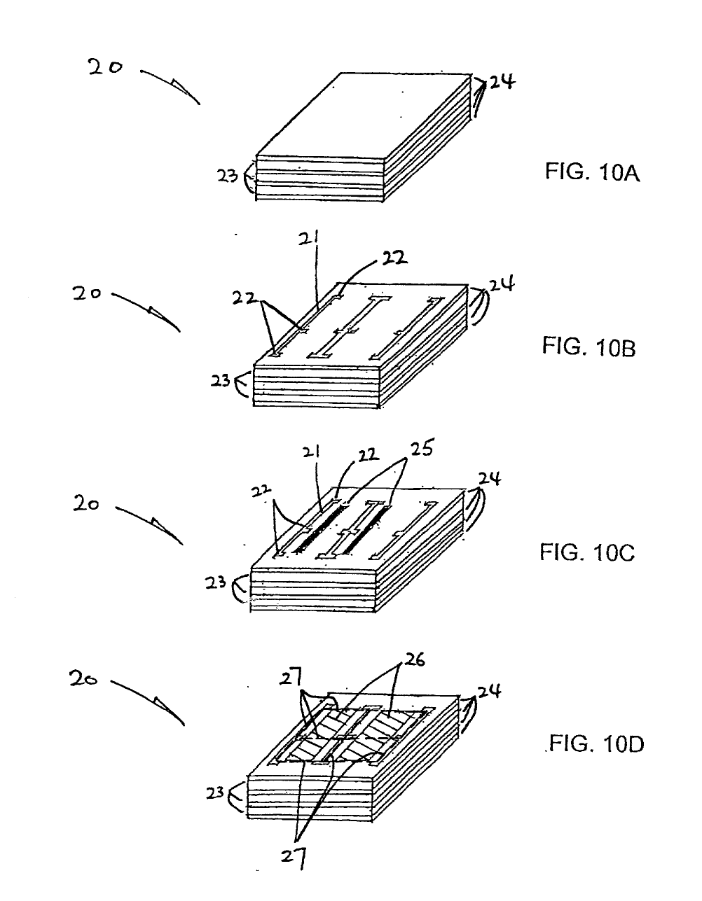

FIGS. 10A to 10D show the method of manufacturing the PTC chip 400, which is substantially the same as the method of manufacturing the first PTC chip 100 as described in relation to FIGS. 3A to 3D, with equivalent parts designated by the same reference numerals increased by “10”. The only difference lies in the shape and location of the holes 22 in the present case, which are equivalent to the previous circular holes 12.

Each hole 22 is rectangular (or square) in shape and is located at a position relative to the relevant slot 21 and corresponding to a corner position for a PTC chip 400 to be cut out from the lamination 20, to provide a right-angled corner for the PTC chip 400. Due to the presence of the hole 22, a left/right side surface of the respective corner of the PTC chip 400 is exposed for plating with copper to form the left/right wall 424 of the resulting terminal 420.

It is understood that the body 410 of the PTC chip 400 may comprise at least two conductive PTC polymer sheets 430 and at least one intermediate conductive metal foil 440.

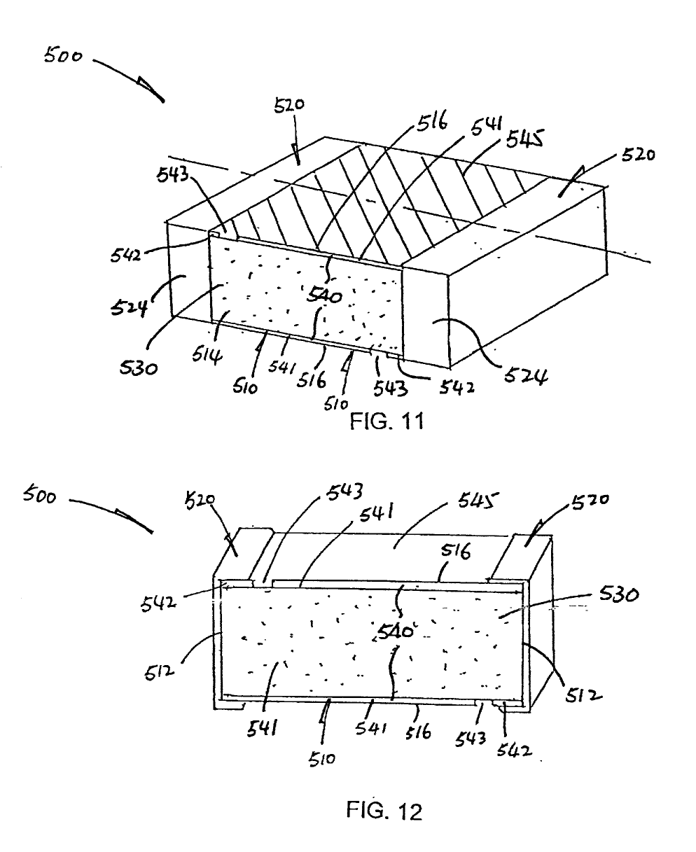

Referring finally to FIGS. 11 and 12 showing a fifth surface mountable PTC chip 500 embodying the invention, this chip 500 has almost the same construction as the fourth PTC chip 400 and is manufactured by identical method, with equivalent parts designated by the same reference numerals increased by “100”. The major difference lies in the use of only one single PTC polymer sheet 530 and hence omission of two inner copper foils. The two outer copper foils 540 of course remain, which interlace with the polymer sheet 530 to form a sandwiched structure.

The invention has been given by way of example only, and various modifications of and/or alterations to the described embodiments may be made by persons skilled in the art without departing from the scope of the invention as specified in the appended claims.

What is claimed is:

1. A surface mountable PTC chip comprising a flat rectangular cuboidal body having opposite first and second ends or end surfaces and top and bottom surfaces and formed by at least two conductive PTC polymer sheets and top and bottom and at least one intermediate conductive metal foil interlacing with the polymer sheets to form a multi-layered structure, said polymer sheets being integrally inter-connected, each of said top and bottom metal foils being divided by a transversely extending gap to form a pair of larger and smaller electrodes at opposite positions as compared between the top and the bottom surfaces of the body, said at least one intermediate metal foil extending from one end surface of the body and reaching short of the opposite end surface to permit integral inter-connection of the polymer sheets, a pair of electrical terminals located at respective opposite ends of the body, each of which covers substantially the entire respective end surface of the body and covers and is in electrical contact with adjoining portions of the larger and smaller electrodes on the top and bottom surfaces of the body, and one of which is in electrical contact with an end of said intermediate metal foil extending from the same body end exposed on that end surface, and an insulating layer located on each of the top and bottom surfaces of the body between the two terminals, wherein each end of the body has a recessed surface profile formed by a recess extending across the top and bottom surfaces of the body and the corresponding terminal assumes substantially the same recessed surface profile.

2. The PTC chip as claimed in claim 1, wherein the body is formed by at least three said conductive PTC polymer sheets and said top and bottom and at least two said intermediate conductive metal foils interlacing with the polymer sheets to form a multi-layered structure, said at least two intermediate metal foils extending in opposite directions from respective first and second end surfaces of the body and reaching short of the opposite end surfaces to permit integral inter-connection of the polymer sheets, and wherein each electrical terminal is in electrical contact with an end of the respective intermediate metal foil extending from the same body end exposed on that end surface.

3. The PTC chip as claimed in claim 1, wherein each recess is formed at substantially the central position of the corresponding end of the body.

4. The PTC chip as claimed in claim 1, wherein each recess has a curved cross-section.

5. The PTC chip as claimed in claim 4, wherein each recess is substantially semi-cylindrical.

6. The PTC chip as claimed in claim 4, wherein each recess occupies substantially the entire width of the corresponding end of the body.

7. The PTC chip as claimed in claim 1, wherein each recess has a substantially V-shaped cross-section.

8. The PTC chip as claimed in claim 7, wherein each recess occupies substantially the entire width of the corresponding end of the body.

9. A surface mountable PTC chip comprising a flat rectangular cuboidal body having opposite first and second ends or end surfaces and top and bottom surfaces and formed by at least one conductive PTC polymer sheet and at least top and bottom conductive metal foils interlacing with the polymer sheet to form a multi-layered structure, each of said top and bottom metal foils being divided by a transversely extending gap to form a pair of larger and smaller electrodes at opposite positions as compared between the top and the bottom surfaces of the body, a pair of electrical terminals located at respective opposite ends of the body, each of which covers and is in electrical contact with adjoining portions of the larger and smaller electrodes on the top and bottom surfaces of the body, and an insulating layer located on each of the top and bottom surfaces of the body between the two terminals, wherein each terminal is in the form of a cap covering the entire respective end surface of the body and the adjoining portions of all four side surfaces of the body surrounding the same body end.

10. The PTC chip as claimed in claim 9, wherein the body is formed by at least two conductive PTC polymer sheets and top and bottom and at least one intermediate conductive metal foil interlacing with the polymer sheets to form a multi-layered structure, said polymer sheets being integrally inter-connected, said at least one intermediate metal foil extending from one end surface of the body and reaching short of the opposite end surface to permit integral inter-connection of the polymer sheets.

11. The PTC chip as claimed in claim 10, wherein the body is formed by at least three said conductive PTC polymer sheets and said top and bottom and at least two said intermediate conductive metal foils interlacing with the polymer sheets to form a multi-layered structure, said at least two intermediate metal foils extending in opposite directions from respective first and second end surfaces of the body and reaching short of the opposite end surfaces to permit integral inter-connection of the polymer sheets.

12. The PTC chip as claimed in claim 10 or claim 11, wherein the or each intermediate metal foil has an end edge exposed on the end surface of the body from which the foil extends and opposite left and right side edges exposed on respective left and right side surfaces of the body, and the terminal at the same body end is in electrical contact with said end edge and adjoining portions of said left and right side edges.

13. The PTC chip as claimed in claim 9, wherein each terminal is in the form of a substantially rectangular cap formed by an end wall and four side walls.
